(19) United States
(12) Patent Application Publication
(10) Pub. No.: US 2010/0315329 A1
(43) Pub. Date: Dec. 16, 2010

(54) WEARABLE WORKSPACE

(75) Inventors: Fred Henry PREVIC, San Antonio, TX (US); Warren Carl COUVILLION, JR., San Antonio, TX (US); Kase J. SAYLOR, San Antonio, TX (US); Ray D. SEEGMILLER, San Antonio, TX (US)

Correspondence Address: GROSSMAN, TUCKER, PERREAULT & PFLEGER, PLLC, 55 SOUTH COMMERICAL STREET, MANCHESTER, NH, 03101, US

(73) Assignee: SOUTHWEST RESEARCH INSTITUTE, San Antonio, TX (US)

(21) Appl. No.: 12/483,950

(22) Filed: Jun. 12, 2009

(51) Int. Cl. G09G 5/00; G10L 21/06

(52) U.S. Cl. 345/156; 345/8; 704/275

(57) ABSTRACT

The present disclosure relates to a wearable workspace system which may include an input device and a head worn display coupled to a wearable computer. The input device may be configured to detect user input data wherein the user input data is provided by a user hands-free. The computer may be configured to: store an electronic technical manual, receive the detected user input data and generate an output based on the recognized user input data. The head worn display may be configured to display at least a portion of the electronic technical manual to the user while allowing the user to simultaneously maintain a view of a work piece. The display may be further configured to receive the output from the computer and to adjust the at least a portion of the electronic technical manual displayed to the user based on the output.

### FIELD OF THE INVENTION

This disclosure relates to a system, method and article configured for hands-free access to, e.g., technical documentation, related to a manual task, including navigating within the documentation and/or data entry.

### BACKGROUND

Electronic technical manuals (ETMs) offer many advantages over traditional paper-based manuals. For example, because they are stored electronically, a relatively large number of manuals may be stored in a relatively small volume, e.g., a CD, a DVD or a hard disk. Each ETM may be easily and/or wirelessly downloaded and/or updated. Further, a relatively large number of ETMs may be stored on a single platform and may be relatively easily shared by a number of users.

While the use of ETMs is rapidly increasing, the benefits of ETMs may be limited by the need to access the information using computer systems that may take the user away from the task at hand. For example, a user, e.g., a technician, who is assembling or disassembling an electrical and/or mechanical system may be required to move from the electrical and/or mechanical system to a computer system that contains the ETM and back to the electrical and/or mechanical system. The technician may also be required to put down tools to free his or her hands in order to use a mouse or keyboard to navigate through the ETM. Additionally, the technician may not be able to view the ETM and the electrical and/or mechanical system simultaneously and may therefore not always detect minor differences between the electrical and/or mechanical system and a diagram or schematic, for example, in the ETM.

Accordingly, there may be a need for a wearable workspace that includes a portable, e.g., wearable, display system that provides a capability of accessing and/or navigating in an ETM without hand-based inputs and without requiring a user to significantly change his or her field of view. It may be desirable to provide a capability for data entry related to the ETM.

### SUMMARY

The present disclosure relates in one embodiment to a wearable workspace system. The system includes an input device configured to be worn by a user and configured to detect user input data wherein the user input data is provided by the user, hands-free and a wearable computer coupled to the input device. The wearable computer is configured to: store an electronic technical manual, receive the detected user input data, recognize the detected user input data and generate an output based on the recognized user input data. The system further includes a head worn display coupled to the computer and configured to display at least a portion of the electronic technical manual to the user while allowing the user to simultaneously maintain a view of a work piece. The display is further configured to receive the output from the computer and to adjust the at least a portion of the electronic technical manual displayed to the user based on the output.

The present disclosure relates in another embodiment to a method for a wearable workspace. The method includes providing an electronic technical manual wherein the electronic technical manual is stored on a wearable computer; displaying at least a portion of the electronic technical manual to a user on a head worn display wherein the head worn display is configured to allow the user to simultaneously maintain a view of a work piece; and adjusting the displayed portion of the electronic technical manual based at least in part on a user input wherein the user input is hands-free.

In yet another embodiment, the present disclosure relates to an article comprising a storage medium having stored thereon instructions that when executed by a machine result in the following operations: receiving a detected user input wherein the detected user input is provided hands-free; determining an action corresponding to the detected user input wherein the action corresponds to adjusting a displayed portion of an electronic technical manual or to storing the detected user input; and providing an output corresponding to the action to a translator module or a data entry module based at least in part on the action wherein the translator module is configured to translate the output into an instruction to a display program to adjust the displayed portion of the electronic manual based on the instruction and the data entry module is configured to receive and store the detected user input.

### BRIEF DESCRIPTION OF THE DRAWINGS

The detailed description below may be better understood with reference to the accompanying figures which are provided for illustrative purposes and are not to be considered as limiting any aspect of the invention.

FIG. 1 depicts a sketch of a user wearing an embodiment of a wearable workspace system consistent with the present disclosure.

FIGS. 2A and 2B depict an illustration of a user's head including definitions of head motion and a plurality of arrows illustrating examples of kinemes, respectively.

FIG. 3 depicts an exemplary wearable workspace system block diagram consistent with the present disclosure.

FIGS. 4A through 4D depict exemplary flow charts for training, main program flow, navigation and data entry, respectively.

FIGS. 5A and 5B depict two examples of a wearable workspace system in use.

FIG. 6 illustrates an example of a wearable workspace system that contains a processor, machine readable media and a user interface.

### DETAILED DESCRIPTION

In general, the present disclosure describes a system and method that may allow a user to select, access, display and/or navigate through an electronic technical manual (ETM) in a hands-free manner. The ETM may be stored in a wearable, e.g., a relatively small, computer and may be displayed on a head worn display (HMD) that allows the user to simultaneously view the ETM and a work piece. The system and method may allow the user to enter and store data and/or narration, e.g., dictation, in a hands-free manner. User inputs may include gestures, e.g., head movements, and/or speech data, e.g., voice commands. User inputs may be detected, i.e., captured, by, e.g., a motion sensor for gestures and/or a microphone for voice commands. Each detected user input may be provided to a recognition module that may be configured to recognize the detected user input, i.e., to determine whether the detected user input corresponds to predefined user input in a stored list of predefined user inputs, and determine a desired action, e.g., navigation and/or data entry, based on the recognized user input. For example, a navigation action in a displayed ETM may include: paging up and/or down, scrolling up and/or down, scrolling left and/or right, zooming in and/or out, etc. The action corresponding to the recognized user input may then be provided to a command interpreter/translator module configured to translate the action into an instruction corresponding to a mouse and/or keyboard command and/or to a data entry module configured to receive and store user data and/or narration. The instruction may then be provided to a display program that is displaying the ETM. The display program may then adjust the displayed ETM according to the instruction. Accordingly, the user may select, access and/or navigate in an ETM and/or enter and store data, hands-free, using gestures and/or voice commands without substantially adjusting his or her field of view, i.e., while maintaining the work piece in his or her field of view.

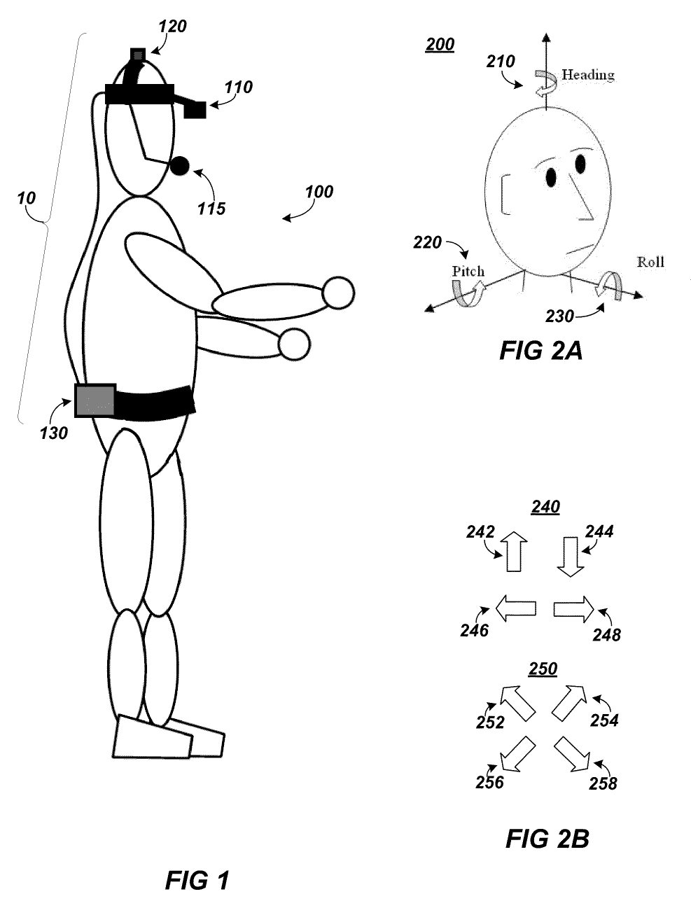

Attention is directed to FIG. 1 which depicts an illustrative embodiment of a wearable workspace 10 as may be worn by a user 100. For illustrative purposes, the user 100 is depicted in ellipsoidal form. The system 10 may include a display for the user 100, such as a head worn display (HMD) 110, a sound sensing device such as a microphone 115 and/or a gesture sensing device such as a motion sensor 120, and a computer, e.g., wearable (miniature) computer 130. Accordingly, a display herein may be understood as a screen or other visual reporting device that provides an image to a user.

The HMD 110 and the microphone 115 and/or motion sensor 120 may be coupled to the computer 130. The user 100 may be wearing the HMD 110, the microphone 115 and/or motion sensor 120 and the computer 130. Accordingly, the HMD 110, microphone 115, motion sensor 120 and computer 130 may be relatively small and relatively light weight.

The HMD 110 may be relatively low cost and may be monocular. In other words, the HMD 110 may display an image, e.g., of a portion of an ETM, to one of the user's 100 eyes. The HMD 110 may display the image to either the user's 100 left eye or right eye. The user 100 may select which eye receives the image. The HMD 110 may further include a flexible mount. The flexible mount may facilitate moving the display of the image from one eye to the other. The flexible mount may enhance the comfort of the user 100 while the user is wearing the HMD 110. The flexible mount may also accommodate different users with a range of head sizes. The HMD 110 may be relatively lightweight to further enhance a user's comfort.

For example, the HMD 110 may be an optical see-through type. Accordingly, the user 100 may see his or her surroundings, e.g., work area and/or work piece, through and/or adjacent to the image. In other words, the image may be projected on a transparent or semitransparent lens, for example, in front of one the user's 100 eyes. With this eye, the user 100 may then perceive both the image, e.g., a portion of an ETM, and his or her work area and/or work piece simultaneously with the image. The user 100 may also perceive his or her work area with his or her other eye, i.e., the eye that is not perceiving the image.

The HMD 110 may be capable of variable focus. In other words, the focus of the image may be adjustable by the user 100. It may be appreciated that variable focus may be useful for accommodating different users. Similarly, the HMD 110 may be capable of variable brightness. Variable brightness may accommodate different users. Variable brightness may also accommodate differences in ambient lighting over a range of environments.

The HMD 110 may be further capable of receiving either analog or digital video input signals. The HMD 110 may be configured to receive these signals either over wires (“hardwired”) or wirelessly. Wireless may be IEEE 802.11a, b, g, n or y, IEEE 802.15.1 (“Bluetooth”) or may be infrared, for example. In an embodiment, the HMD 110 may include VGA and/or SVGA input ports configured to receive video signals from computer 130. It may be appreciated that SVGA as used herein includes resolution of at least 800×600 4-bit pixels, i.e., capable of sixteen colors. In other embodiments, the HMD 110 may include digital video input ports, e.g., USB and/or a Digital Visual Interface.

The microphone 115 and/or the motion sensor 120 may each be configured to detect, i.e., capture, a user input. For example, the microphone 115 may be configured to capture a user's speech, e.g., a voice command. The motion sensor 120 may be configured to capture a gesture, e.g., a motion of a user's head. The microphone 115 may be relatively small to facilitate being worn by the user 100. In an embodiment, the microphone 115 may be a noise-cancellation microphone. For example, a noise-cancellation microphone may be configured to detect a voice in an environment with background noise. The noise-cancellation microphone may be configured to detect and amplify a voice near the microphone and to detect and attenuate or cancel background noise.

The motion sensor 120 may be relatively small and relatively lightweight. For example, a motion sensor may include a three degrees of freedom (DOF) tracker configured to track an orientation of a user's head. Orientation may be understood as a rotation of the user's head about an axis. A three DOF tracker may be configured to detect an orientation about one or more of three orthogonal axes. The motion sensor 120 may be generally positioned on top of a user's head and may be generally centered relative to the top of the user's head. For example, the motion sensor 120 may be configured to detect an orientation, i.e., an angular position, of the user's head. Angular position and/or a change in angular position as a function of time may be used to determine, e.g., a rate of change of angular position, i.e., angular velocity. The motion sensor 120 may be configured to detect an angular position of a user's head, a change in angular position and/or an angular velocity, of a user's head.

For example, the motion sensor 120 may be mounted on top of a user's head and may be configured to detect angular position changes, e.g., pitch, roll and heading changes, and angular velocities, of the user's head. Attention is directed to FIG. 2A, depicting a user's head 200 with heading 210, pitch 220 and roll 230 motions defined. For example, heading 210 motion may include rotating the head from left to right and/or right to left. Pitch 220 motion may include moving the head up and/or down, a motion similar to, e.g., nodding one's head. Roll 230 motion may include tipping one's head from side to side, i.e., moving one's left ear closer to one's left shoulder or moving one's right ear closer to one's right shoulder.

In an embodiment, the HMD 110 and the microphone 115 and/or motion sensor 120 may be coupled to a head band worn by the user 100. In another embodiment, the HMD 100 and the microphone 115 and/or motion sensor 120 may be configured to be mounted to protective head gear, e.g., a hard hat, as may be worn in some work environments.

The computer 130 may be configured to be worn by a user 100. For example, the wearable computer 130 may be coupled to a belt and may be worn around a user's waist. In another example, the wearable computer 130 may be carried in, e.g., a knapsack, worn by the user 100. The wearable computer 130 may be relatively small and relatively light weight, i.e., may be miniature. For example, the computer may be a UMPC (“Ultra Mobile Personal Computer”) or a MID (“Mobile Internet Device”). A UMPC or MID may be understood as a relatively small form factor computer, e.g., generally having dimensions of less than about nine inches by less than about six inches by less than about two inches, and weighing less than about two and one-half pounds. In another example, the wearable computer 130 may be a portable media player (“PMP”). A PMP may be understood as an electronic device that is capable of storing and/or displaying digital media. A PMP may generally have dimensions of less than about seven inches by less than about five inches by less than about one inch, and may weigh less than about one pound. As used herein, “about” may be understood as within ±10%. It may be appreciated that the physical dimensions and weights listed above are meant to be representative of each class of computers, e.g., UMPC, MID and/or PMP, and are not meant to be otherwise limiting.

Accordingly, the wearable workspace 10 may include an input device, e.g., motion sensor 120 and/or microphone 115, configured to capture a user input, e.g., gesture and/or voice command. The input devices may be coupled to a computer, e.g., wearable computer 130, configured to be worn by the user 100. The wearable computer 130 may be configured to store the ETM and may be coupled to a display device, e.g., HMD 110, configured to display at least a portion of the ETM to the user 100. The wearable computer 130 may be further configured to store display software as well as program modules. The program modules may be configured to receive detected (captured) user inputs, to determine an action corresponding to the detected user input, to translate the action into an instruction, e.g., a mouse and/or keyboard command, and to provide the instruction to the display software. A program module may be configured to provide a user a data entry utility. In this manner, the system and method may provide hands-free access to and/or navigation in an ETM displayed on an HMD as well as hands-free data entry.

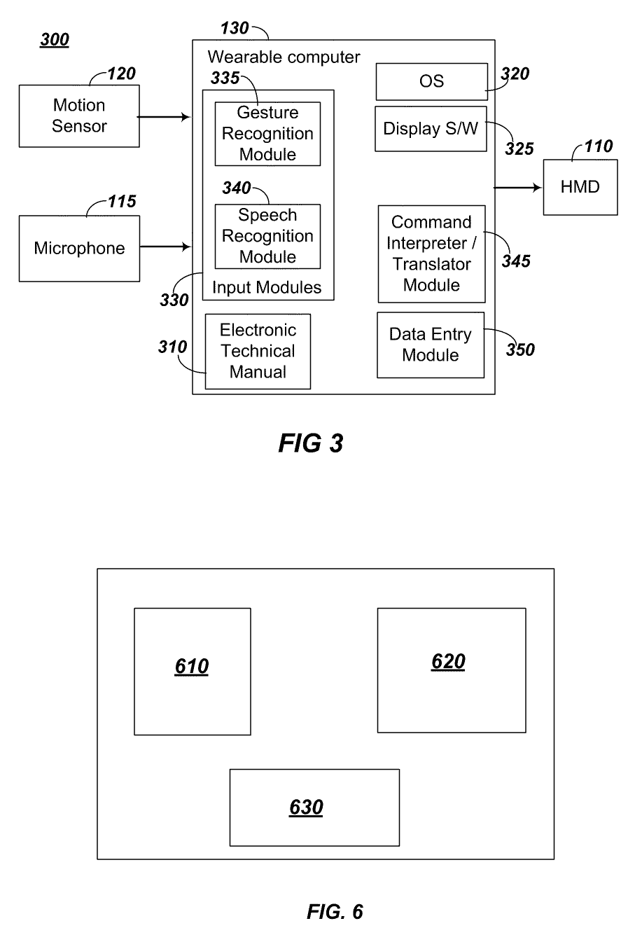

Attention is directed to FIG. 3 which is a system block diagram 300 of an embodiment of the wearable workspace 10. The system 300 may include a motion sensor 120 and/or microphone 115 and a head worn display (HMD) 110 coupled to a wearable computer 130. The motion sensor 120, microphone 115 and HMD 110 may be coupled to the wearable computer 130 with wires or wirelessly. For example, wireless coupling may include, e.g., IEEE 802.11a, b, g, n or y and/or IEEE 802.15.1 (“Bluetooth”) wireless protocols. The wearable computer 130 may be configured to store one or more Electronic Technical Manuals 310 (ETMs), an operating system (OS) 320 that may include a display program (Display S/W) 325, one or more input modules 330, a command interpreter/translator module 345 and/or a data entry module 350.

The display program 325 may be configured to display an ETM. For example, the ETM 310 may be stored in portable document format (“pdf”) which may be displayed by Adobe Reader available from Adobe Systems, Inc. In another example, the ETM 310 may be stored as a document that may be displayed by, e.g., Microsoft WORD available from Microsoft, Inc. Generally, the display program 325 may be configured to receive instructions from the OS 320 corresponding to a mouse movement, a mouse button press and/or a keyboard key press. In response to the OS instruction, a cursor may move, e.g., in or on a displayed portion of an ETM, the displayed portion of the ETM may be adjusted, an item may be selected, a menu item may be displayed, or some other action, as may be known to one skilled in the art may occur. Accordingly, access, navigation, selection, etc., in an ETM may be based on an OS instruction to a display program, e.g., Display S/W 320.

The input modules 330 may be configured to receive user input data from one or more user input devices, e.g., microphone 115 and/or motion sensor 120. For example, user input modules 330 may include a gesture recognition module 335 and/or a speech recognition module 340. The gesture recognition module 335 may be configured to receive the user's head orientation data from motion sensor 120 and to generate an output based on the motion sensor data. For example, the gesture recognition module 335 may be configured to determine a change in the user's head orientation and/or a rate of change of the user's head orientation (angular velocity) based at least in part on the head orientation data. Similarly, the speech recognition module 340 may be configured to receive user speech data from microphone 115 and to generate an output based on the user speech data.

It may be appreciated that a user may move his or her head in an infinite number of ways. In order to use head movement as a command input, a finite number of orientations and/or changes in orientation (“gesture vocabulary”) may be defined, i.e., predefined. As used herein, a gesture vocabulary may be understood as a finite number of predefined orientations and/or changes in orientation, i.e., gestures, corresponding to desired commands and/or data entry parameters. The gesture vocabulary may be defined based on, e.g., ease of learning by a user and/or ease of detection and/or differentiation by a motion sensor. In some embodiments the gesture vocabulary may be customizable by a user, based, e.g., on the user's particular application and/or user preference. As further used herein, a “kineme” may be understood as a continuous change in orientation. For example, each kineme may include a change in angular position. A change in angular position may be based on a minimum (threshold) change in angular position. Each kineme may include an angular velocity for each change in angular position. A gesture may then include a combination of kinemes occurring in a specific order, at or above a minimum change in angular position and/or at or above a minimum (threshold) angular velocity. A vocabulary may then include a finite number of predefined gestures.

Attention is directed to FIG. 2B which depicts kinemes symbolically corresponding to changes in head orientation. It should be noted that angular velocity data is not explicitly shown in FIG. 2B. For example, a first kineme group 240 includes kinemes corresponding to changes in orientation about a single axis. In other words, the first group of kinemes 240 corresponds to head movement resulting only in heading 210 changes 246, 248 or resulting only in pitch 220 changes 242, 244. Pitch changes correspond to a user rotating his or her head up or down and heading changes correspond to a user rotating his or her head left or right. A second kineme group 250 includes kinemes corresponding to changes in orientation about two axes. In other words, the second group of kinemes 250 corresponds to head movement resulting in both heading 210 and pitch 220 changes. For example, a user rotating his or her head up and to the left corresponds to kineme 252, up and to the right to kineme 254, down and to the left to kineme 256 and down and to the right kineme 258. It should be noted that since each kineme is defined as a continuous motion, a user rotating his or her head up and then to the right corresponds to kineme 242 followed by kineme 248 while a user rotating his or her head up and to the right as a continuous motion corresponds to kineme 254.

It may be appreciated that the exemplary kinemes are not exhaustive, e.g., do not include roll 230. It was discovered during experimentation that changes in orientation corresponding to roll 230 were relatively more difficult for test subjects to learn and repeat. Other kinemes may be defined, including roll 230, depending on a particular application and may be within the scope of the present disclosure.

It may be appreciated that a gesture may be defined by combining a sequence of one or more kinemes. For efficiency, e.g., user learning (training time), and efficacy, e.g., ease of gesture detection and differentiation, a vocabulary of gestures using relatively short kineme sequences may be desirable. Table 1 is an example of gestures (kineme sequences) corresponding to relatively common navigation activities as well as gestures specific to the wearable workspace. In the table, the kinemes are represented symbolically and correspond to head motions described relative to FIGS. 2A and 2B.

TABLE 1

| Action | Gesture (Kineme Sequence) |
|---|---|
| Bookmarks | [symbol] |
| Select (Enter) | [symbol] |
| Scroll Down | [symbol] [symbol] |
| Page Down | [symbol] [symbol] [symbol] [symbol] |
| Scroll Up | [symbol] [symbol] |
| Page Up | [symbol] [symbol] [symbol] [symbol] |
| Zoom In | [symbol] [symbol] |
| Zoom Out | [symbol] [symbol] |
| Scroll Left | [symbol] [symbol] |
| Scroll Right | [symbol] [symbol] |
| Escape | [symbol] [symbol] [symbol] |
| Restore Hand Cursor | [symbol] [symbol] |
| Center Cursor | [symbol] [symbol] [symbol] |

As discussed above, motion sensing and capture for head movement may include changes in orientation, i.e., changes in angular position, and angular velocity, i.e., rate of change of angular position. Although not explicitly shown in Table 1, kineme definitions may include an angular velocity parameter. For example, head motions that include angular velocities at or greater than a threshold velocity may be considered candidate gestures. Whether a user's head motion is ultimately determined to be a gesture may depend on a particular change in orientation and/or a rate of change of orientation, i.e., angular velocity. For example, for the exemplary vocabulary shown in Table 1, a roll motion 230 may not result in a determination that a gesture has been captured. In another example, head motions that include angular velocities below the threshold velocity and/or changes in orientation below the threshold change in orientation may not be considered candidate gestures. A threshold change in orientation may be configured to accommodate user head movement that is not meant to be a gesture. A threshold velocity may be configured to allow a user to move his or her head without a gesture being detected or captured, e.g., by changing orientation with an angular velocity less than the threshold angular velocity. The threshold velocity may allow a user to reset his or her head to a neutral position, e.g., by rotating his or her head relatively slowly. User training may include learning a change in orientation corresponding to the minimum change in orientation and/or an angular velocity corresponding to the threshold angular velocity.

Accordingly, gesture recognition module 335 may be configured to receive a user's head orientation data from a motion sensor, e.g., motion sensor 120, and to generate an output based on the motion sensor data. For example, the gesture recognition module 335 may determine whether a detected change in the user's head orientation corresponds to a gesture by comparing the received head orientation data to a list of predefined gestures, i.e., a gesture vocabulary. If the head orientation data substantially matches a predefined gesture then the gesture recognition module 335 may provide an output corresponding to an action associated with the predefined gesture to, e.g., command interpreter/translator module 345.

Turning again to FIG. 3, the speech recognition module 340 may be configured to generate an output based on user speech, e.g., a voice command. The wearable workspace 10 may be used in environments with a relatively high ambient, i.e., background, noise level, e.g., industrial situations, test facilities, etc. In some situations, the effects of ambient noise may be reduced and/or mitigated using, e.g., a noise-cancellation microphone. Speech recognition accuracy and/or speed may depend on a number of factors including ambient noise, user training and/or a number of “speech elements,” e.g., voice commands, to be recognized. As used herein a “speech element” may be understood as one or more predefined words corresponding to a voice command and/or a data entry parameter, e.g., number, letter, and/or parameter name. A speech vocabulary may be understood as a finite number of predefined speech elements. For the wearable workspace 10, the number of speech elements may be based on desired activities. A speech vocabulary may be defined by a user and/or a speech element may be chosen based on relative ease of learning by a user and/or relative ease of detection and/or capture by a speech recognition module. For example, selecting, displaying, accessing and navigating in ETMs may require a relatively small number of commands which may increase speech recognition accuracy.

In some situations it may be desirable to include a data entry utility. For example, in a test environment, it may be desirable to record user speech and/or to capture and store user input data, including e.g., alphanumeric characters (numbers and letters). Data entry commands may include, e.g., “Data entry”, “Data entry stop”, “Record”, “Record start” and/or “Record stop”. “Data entry” may be configured to indicate that subsequent input data is to be stored and “Data entry stop” may be configured to indicate that subsequent input data may be interpreted as a command. Similarly, speech data that includes “Record” may be configured to indicate speech input data that is to be recorded as speech, i.e., narration.

Table 2 is an example of a speech vocabulary including voice commands that may be used in a wearable workspace. It may be appreciated that more than one speech element may correspond to an action. For example, a “Scroll Up” action may be initiated by voice commands: “Scroll up”, “Move up”, and/or “Up”.

TABLE 2

| Action | Voice Command |
|---|---|
| Scroll Up | Scroll up, Move up, Up |
| Scroll Down | Scroll down, Move down, Down |
| Scroll Left | Scroll left, Left |
| Scroll Right | Scroll right, Right |
| Page Up | Page up |
| Page Down | Page down |
| Zoom In | Zoom in |
| Zoom Out | Zoom out |
| Show/Hide Bookmarks Menu | Bookmarks |
| Return (Enter or Select) | Return |
| Escape | Escape |
| Turns on locking mode. (Scrolling | Lock on |
| controlled by head motions. | |
| Voice commands ignored.) | |
| Turns off locking mode. | Lock off |
| (Voice commands active.) | |
| Restore Cursor | Hand |
| Center Cursor | Center |
| Exits Speech Recognizer | Exit |

Speech recognition module 340 may be configured to receive speech data from, e.g., microphone 115. The speech recognition module 340 may then determine whether the speech data corresponds to a predefined voice command and/or data entry parameter. For example, speech recognition may be performed by commercially available off-the-shelf speech recognition software, as may be known to those of ordinary skill in the art. Whether speech data corresponds to a predefined voice command and/or data entry parameter may be determined by comparing recognized speech data to a list of predefined speech elements, including the predefined voice commands and data entry parameters. If the recognized speech data matches a speech element, then an output corresponding to an action associated with that speech element may be provided to, e.g., command interpreter/translator module 345.

It may be appreciated that user input data may include gestures and/or speech data, e.g., speech elements and/or narration. For example, gestures may be used for navigation in an ETM while speech data may be used for data entry. In another example, gestures and/or speech elements may be used for navigation. In yet another example, a keypad and/or keyboard may be displayed on, e.g., the HMD, and a user may select “keys” using gestures, thereby providing data entry based on gestures. An appropriate configuration may depend on the application, e.g., whether a user may be speaking for other than navigation or data entry purposes.

The input modules 330 may be configured to recognize the user input data and to provide recognized user input data corresponding to an action, e.g., navigation, to a command interpreter/translator module 345. The input modules 330 may be configured to provide recognized user input data corresponding to a data entry command and/or data entry data to a data entry module 350. The command interpreter/translator module 345 may be configured to translate the recognized user input data into an instruction corresponding to, e.g., a mouse motion, mouse button press and/or a keyboard key press, and to provide the instruction to the OS 320 and/or display software 325. The data entry module 350 may be configured respond to a recognized command and/or to store the user input data.

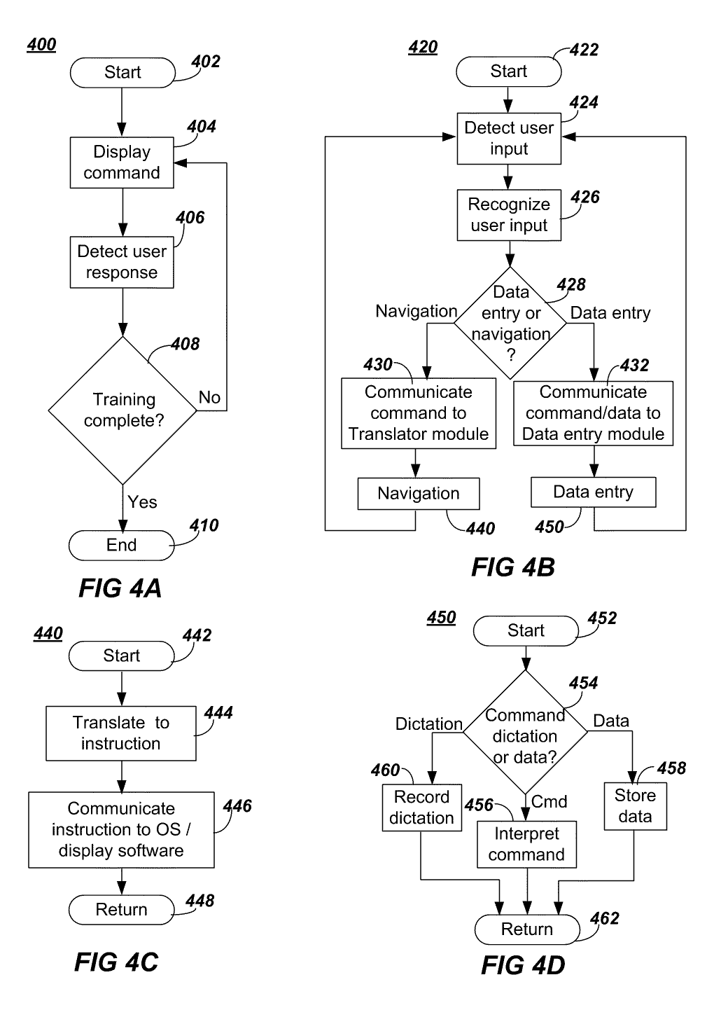

Attention is directed to FIGS. 4A through 4D which depict illustrative flow charts for the wearable workspace. A training flow chart 400 depicted in FIG. 4A corresponds to a training sequence. A main flow chart 420 depicted in FIG. 4B corresponds to a portion of main program flow. A navigation flow chart 440 depicted in FIG. 4C corresponds to a navigation sequence and a data entry flow chart 450 depicted in FIG. 4D corresponds to a data entry sequence.

It may be appreciated that recognition of a user input may be improved with training. For example, a speech recognition module, e.g., speech recognition module 340, may provide more accurate speech recognition with training. In another example, a gesture recognition module, e.g., gesture recognition module 335, may likewise provide more accurate gesture recognition if a user is trained including, e.g., providing feedback to a user in response to a user head motion. The feedback may include an output of the gesture recognition module, provided or displayed to a user, corresponding to the user head motion. The output may include, e.g., a kineme, head orientation and/or angular velocity. Gesture training may include both head orientation and head motion angular velocity feedback to a user. In this manner, a user may be trained to provide head motion above a threshold change in orientation and above a threshold angular velocity for gestures and below the thresholds for non-gesture head movement. Gesture training may include a calibration activity. The calibration activity may be configured to determine a threshold change in orientation and/or a threshold angular velocity for a user. For example, a sequence of kinemes may be displayed to the user. The sequence of kinemes displayed to the user may further include an angular velocity indicator, e.g., “fast” or “slow”. The user may adjust the orientation of his or her head in response to the displayed kineme. The user may adjust the orientation of his or her head according to the angular velocity indicator. Detected angular velocities corresponding to “fast” and/or “slow” may be used to set a threshold angular velocity. Similarly, a user may be provided an instruction to adjust an orientation, i.e., angle, of his or her head to a maximum angle that a user may consider as “still”. “Still” may be understood as corresponding to a maximum angle, below which, a head motion may not be detected. The maximum angle may be used to set a threshold change in orientation. A maximum angle may be defined for head movement in one or more directions, e.g., pitch, roll and/or yaw. These thresholds, i.e., change in orientation and/or angular velocity, may then be used to customize the wearable workspace for the user.

The training 400 program flow may begin at Start 402. A command may be displayed 404 to a user on, for example, an HMD. For example, the command may include a navigation action, e.g., the words “Scroll up” and/or a sequence of kinemes corresponding to the action “scroll up”. A user response may then be detected 406. For example, the user response may be detected 406 using a microphone, e.g., microphone 115 and/or a motion sensor, e.g., motion sensor 120. The detected user response may then be provided to an input module, e.g., speech recognition module 340 for speech input data and/or gesture recognition module 335 for head motion input data. An output, e.g., an indication of a recognized user input, of the input module 335, 340 may be displayed to the user. Whether the training is complete may then be determined 408. For example, training may be complete if the captured and recognized user response matches the displayed command in a predefined fraction of a predefined number of tries. If training is not complete, (e.g., because the number of tries have not been completed or the fraction of response matches is inadequate), program flow may return to display command 404, and the sequence may be repeated. If training is complete, program flow may end 410. The training program 400 may be repeated for any or all of the gestures and/or speech elements, including voice commands and/or data entry parameters.

It is contemplated that a training sequence, e.g., training program 400, may be used to train a gesture recognition module to recognize user-defined gestures. For example, in response to a displayed command, e.g., the words “Scroll up”, a user may perform a user-defined gesture. The user response may then be detected by, e.g., the motion sensor, and the detected response may be “interpreted” by a gesture recognition module. The command, e.g., “Scroll up”, may be displayed one or more times and each time the user response may be detected and “interpreted”. The sequence may be repeated for each command. Based on the interpreted user responses, changes in head orientation corresponding to each user-defined gesture may be used to generate a user-defined gesture vocabulary.

The main program 420 flow may begin at Start 422. A user input may be detected (captured) 424. For example, the user input may be detected 424 using a microphone, e.g., microphone 115 and/or a motion sensor, e.g., motion sensor 120. The detected user input may then be provided to an input module, e.g., speech recognition module 340 for speech input data and/or gesture recognition module 335 for head motion input data. The detected user input may then be recognized 426. For example, the speech recognition module may select a speech element from a predefined list of speech elements that most closely corresponds to the detected speech input data and/or the gesture recognition module may select a sequence of kinemes from a predefined list of gestures (i.e., kineme sequences) that most closely corresponds to the detected gesture input data.

For example, the predefined list of speech elements may include navigation voice commands as well as data entry commands and/or data. Data may include alphanumeric characters and/or predefined words that correspond to an ETM, an associated task and/or parameters associated with the task, e.g., “engine” and/or one or more engine components for an engine maintenance task. Each predefined list may be stored, e.g., in wearable computer 130.

Whether recognized user input data corresponds to data entry or navigation may then be determined 428. If the recognized user input data corresponds to navigation, i.e., is a command, the command may be communicated 430 to a translator module, e.g., command interpreter/translator module 345. For example, the command may be associated with a message protocol for communication to the translator module. For example, a configuration file, stored on a wearable computer, may be used to associate a detected and recognized user input with a Universal Datagram Protocol (UDP) message configured to be sent to the translator module upon detection and recognition of the user input. A configuration file may be understood as a relatively simple database that may be used to configure a program module without a need to recompile the program module. A UDP may be understood as a network protocol that allows a computer applications to send messages to another computer application without requiring a predefined transmission channel or data path. Program flow may then proceed to Navigation 440.

If the recognized user input data corresponds to data entry, i.e., corresponds to a data entry command and/or data, the data entry command and/or data may be communicated 432 to a data entry module. For example, the data entry command and/or data may be associated with a message protocol for communication to the data entry module. For example, a configuration file, stored on a wearable computer, may be used to associate a detected and recognized user input with a Universal Datagram Protocol (UDP) message configured to be sent to the data entry module upon detection and recognition of the user input. Program flow may then proceed to Data entry 450.

The navigation program 440 flow may begin at Start 442. Upon receipt of an output, e.g., a message, corresponding to a detected and recognized user input from an input module, e.g., speech recognition module 340 and/or gesture recognition module 335, the message may be translated 444 into an instruction corresponding to a mouse and/or keyboard command. The instruction may then be communicated 446 to an operating system, e.g., OS 320 and/or display software, e.g., display software 325. Program flow may then return 448 to the main program 420 flow and may return to detecting user input 424.

For example, a translator module, e.g., command interpreter/translation module 345 may receive a UDP message from an input module 335, 340. The translator module may translate the message into an operating system, e.g., OS 320, instruction corresponding to a mouse motion, mouse button press or keyboard key press. For example, the translator module may use a configuration file to translate a received message corresponding to a detected and recognized user input into an operating system mouse and/or keyboard event. The translator module may then communicate 446 the mouse and/or keyboard event to the operating system, e.g., OS 320, and/or display software, e.g., display software 325. The configuration file may allow a translator module to work with any display software that may be configured to display an ETM. Program flow may then return 448 to the main program 420 flow and may return to detecting user input 424.

The data entry 450 program flow may begin at Start 452. Whether a received data entry message corresponds to a data entry command, data entry data and/or dictation may be determined 454. If the received data entry message corresponds to a command, the command may be interpreted 456. If the received data entry message corresponds to data, the data may then be stored 458. If the received data entry message corresponds to dictation, the dictation may then be recorded 460 and/or stored. Program flow may then return 462 to the main program 420 flow and may return to detecting user input 424.

For example, a data entry module, e.g., data entry module 350, may receive a data entry message from an input module, e.g., gesture recognition module 335 and/or speech recognition module 340, and may then determine 454 whether the data entry message corresponds to a data entry command, dictation or data. If the data entry message corresponds to a data entry command, the data entry module 350, may interpret 456 the command. For example, a data entry command may include, e.g., Record dictation, Store data, Start record, Start store, End record and/or End store. If the data entry command is Record dictation, the data entry module may prepare to record a subsequent data entry message from, e.g., the speech recognition module 340. The data entry module may continue to record the data entry message until an End record command is received. The End record command may be received from, e.g., the gesture recognition module 335 and/or the speech recognition module 340. If the data entry command is Store data, the data entry module may prepare to store subsequent data entry messages from, e.g., the speech recognition module 340 and/or the gesture recognition module. For example, the subsequent data entry messages may include a parameter name for the data to be stored, as a word and/or alphanumeric characters, and/or the data to be stored as, e.g., one or more alphanumeric characters. The data entry module may continue to store subsequent data entry messages until, e.g., an End store command is received.

For example, if data entry is provided based on gestures, a keypad or keyboard may be displayed on, e.g., the HMD. The user may then, by providing appropriate gestures, move a cursor to a desired number and/or letter and select the number and/or letter for data entry. In another example, for speech and/or gesture data entry, a recognized alphanumeric character, word and/or phrase may be displayed to the user on, e.g., the HMD, to provide the user visual feedback that the entered data was accurately recognized.

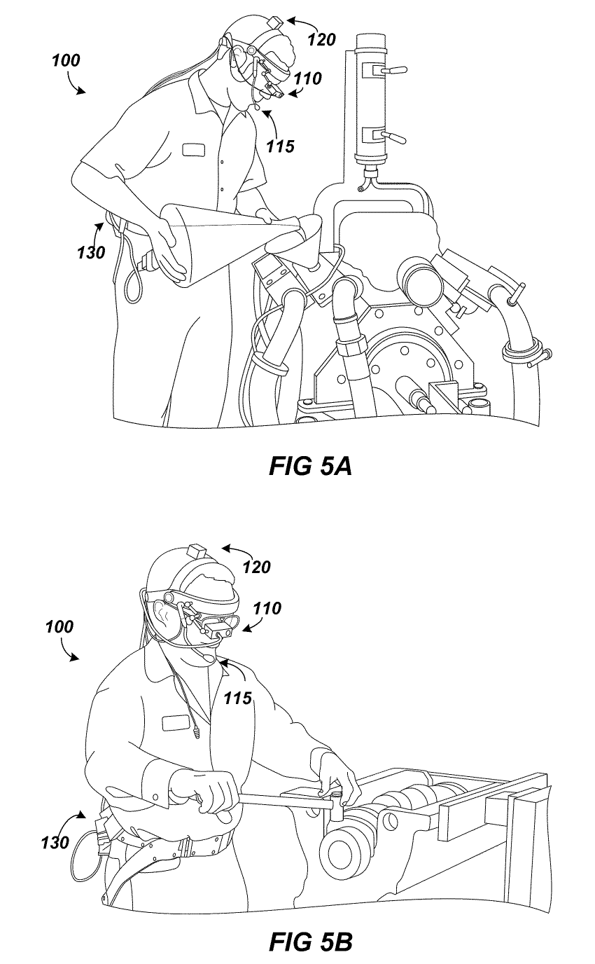

Attention is directed to FIGS. 5A and 5B, depicting two examples of a wearable workspace being used. Each wearable workspace may include an HMD, e.g., HMD 110, a microphone, e.g., microphone 115, a motion sensor, e.g., motion sensor 120 and/or a wearable computer, e.g., wearable computer 130. As shown in FIG. 5A, for example, a user, e.g., user 100, may be performing a test preparation procedure. The procedure may include filling a reservoir with a fluid. For example, the procedure may include filling an engine reservoir (e.g., crank case) with a lubricating fluid (e.g., oil). The user 100 may access an ETM, e.g., ETM 310, using the wearable workspace to determine the type and quantity of fluid required. The ETM 310 may be stored in a computer, e.g., wearable computer 130. The user 100 may then navigate, e.g., scroll, within the ETM 310 to find the desired information. The user 100 may use gestures, e.g., sequences of kinemes, and/or voice commands to access the ETM, to navigate within the ETM and/or to enter data. At least a portion of the ETM may be displayed on an HMD, e.g., HMD 110, worn by the user 100. For example, the ETM may be displayed along an edge of the user's field of view. The user 100 may then similarly access the ETM to determine a location of a fluid fill pipe. The user may also enter data, e.g., an amount of fluid transferred to the reservoir, using the wearable workspace, as discussed in detail above.

As shown in FIG. 5B, for example, a user may be performing an assembly or a disassembly procedure. The assembly procedure may include adjusting a component using a tool. For example, the assembly procedure may include tightening a bolt to a torque specification for a bearing cap configured to hold a main (crank shaft) bearing in an engine. The user 100 may access an ETM to determine the torque specification. The user 100 may further access the ETM to determine a sequence of tightening one or more bolts associated with each of a plurality of main bearings in the engine. The disassembly procedure may include checking a parameter. For example, the disassembly procedure may include determining a torque of bolt for the bearing cap. The user may then enter data representing the determined torque to the ETM for storage. For example, the user may navigate within the ETM using gestures, e.g., head motions corresponding to sequences of kinemes, and/or may enter data using voice commands and/or speech recognition.

It should also be appreciated that the functionality described herein for the embodiments of the present invention may be implemented by using hardware, software, or a combination of hardware and software, as desired. If implemented by software, a processor and a machine readable medium are required. The processor may be any type of processor capable of providing the speed and functionality required by the embodiments of the invention. Machine-readable memory includes any media capable of storing instructions adapted to be executed by a processor. Some examples of such memory include, but are not limited to, read-only memory (ROM), random-access memory (RAM), programmable ROM (PROM), erasable programmable ROM (EPROM), electronically erasable programmable ROM (EEPROM), dynamic RAM (DRAM), magnetic disk (e.g., floppy disk and hard drive), optical disk (e.g. CD-ROM), and any other device that can store digital information. The instructions may be stored on a medium in either a compressed and/or encrypted format. Accordingly, in the broad context of the present invention, and with attention to FIG. 6, wearable workspace system may include a processor (610) and machine readable media (620) and user interface (630).

Although illustrative embodiments and methods have been shown and described, a wide range of modifications, changes, and substitutions is contemplated in the foregoing disclosure and in some instances some features of the embodiments or steps of the method may be employed without a corresponding use of other features or steps. Accordingly, it is appropriate that the claims be construed broadly and in a manner consistent with the scope of the embodiments disclosed herein.

What is claimed is:

1. A wearable workspace system comprising:
an input device configured to be worn by a user and configured to detect user input data wherein said user input data is provided by said user, hands-free;
a wearable computer coupled to the input device, said wearable computer configured to:
store an electronic technical manual,
receive said detected user input data,
recognize said detected user input data and
generate an output based on said recognized user input data; and
a head worn display coupled to said computer and configured to display at least a portion of said electronic technical manual to said user while allowing said user to simultaneously maintain a view of a work piece, said display further configured to receive said output from said computer and to adjust said at least a portion of said electronic technical manual displayed to said user based on said output.

2. The system of claim 1 wherein said input device is a microphone and said user input data is speech.

3. The system of claim 1 wherein said input device is a motion sensor and said user input data comprises an orientation of said user's head.

4. The system of claim 1 wherein said computer is configured to store a list of predefined speech elements.

5. The system of claim 1 wherein said computer is configured to store a list of predefined gestures wherein a gesture comprises a change in orientation of said user's head.

6. The system of claim 1 wherein said computer is an ultra-mobile personal computer, a mobile internet device, or a portable media player.

7. The system of claim 1 wherein said computer is further configured to store said output.

8. The system of claim 1 wherein said input device and said display are coupled to said computer wirelessly.

9. The system of claim 7 wherein said output comprises test data.

10. A method for a wearable workspace comprising:
providing an electronic technical manual wherein said electronic technical manual is stored on a wearable computer;
displaying at least a portion of said electronic technical manual to a user on a head worn display wherein said head worn display is configured to allow said user to simultaneously maintain a view of a work piece; and
adjusting said displayed portion of said electronic technical manual based at least in part on a user input wherein said user input is hands-free.

11. The method of claim 10 further comprising:
detecting said user input using an input device,
recognizing said detected user input using a recognition module stored in said computer, and
providing an output corresponding to said recognized user input to a translator module or a data entry module wherein said translator module and said data entry module are stored on said computer.

12. The method of claim 11 further comprising translating said recognized user input using said translator module.

13. The method of claim 11 further comprising storing data corresponding to said user input using said data entry module.

14. The method of claim 10 wherein said user input comprises speech.

15. The method of claim 10 wherein said user input comprises a gesture.

16. The method of claim 10 further comprising training said user wherein said training comprises displaying a command to said user on said head worn display and detecting a user response to said command wherein said user response is hands-free.

17. An article comprising a storage medium having stored thereon instructions that when executed by a machine result in the following operations:
receiving a detected user input wherein said detected user input is provided hands-free;
determining an action corresponding to said detected user input wherein said action corresponds to adjusting a displayed portion of an electronic technical manual or to storing said detected user input; and
providing an output corresponding to said action to a translator module or a data entry module based at least in part on said action wherein said translator module is configured to translate said output into an instruction to a display program to adjust said displayed portion of said electronic manual based on said instruction and said data entry module is configured to receive and store said detected user input.

18. The article of claim 17 wherein said determining said action comprises:
comparing said detected user input to a list of predefined user inputs, and
selecting an action associated with a predefined user input that most closely matches said detected user input.

19. The article of claim 17 wherein said instructions further result in the following operations: training a user wherein said training comprises displaying a command to said user on a head worn display and detecting a user response to said command.
